(19) United States
(12) Patent Application Publication
(10) Pub. No.: US 2011/0014880 A1
(43) Pub. Date: Jan. 20, 2011

(54) SYSTEM AND METHOD FOR A SINGLE CHIP DIRECT CONVERSION TRANSCEIVER IN SILICON

(76) Inventors: Sean T. Nicolson, Mountain View, CA (US); Ekaterina Laskin, Toronto (CA); Sorin Petre Voinigescu, Scarborough (CA)

Correspondence Address: MILLER THOMPSON, LLP, Scotia Plaza, 40 King Street West, Suite 5800, TORONTO, ON, M5H 3S1, CA

(21) Appl. No.: 12/738,032

(22) PCT Filed: Oct. 10, 2008
(86) PCT No.: PCT/CA2008/001774

§ 371 Date: Jul. 12, 2010

Related U.S. Application Data
(60) Provisional application No. 60/979,849, filed on Oct. 14, 2007.

(51) Int. Cl. H04B 1/40; G06F 17/50

(52) U.S. Cl. 455/86; 716/132

(57) ABSTRACT

A direct conversion radio frequency (RF) transceiver integrated circuit (IC) is provided. The IC includes a local oscillator block, a receiver block, and a transmitter block disposed on a single silicon-based integrated circuit. Each of such blocks are connected to a ground plane that includes a metal located adjacent to each of such blocks, air gaps located between each section of the metal adjacent to such blocks, each section of the metal being connected to the adjacent section of metal in the group plane at a location on the edge of the ground plan corresponding to a point substantially equidistant from the two sections of metal. A system and method is provided for implementing a direct conversion integrated circuit architecture. A clock distribution system is provided, as well as a method for radio detection and ranging (RADAR) using a Doppler RADAR transceiver system in the W-band. A method for noise isolation between blocks of an integrated circuit is also provided.

### PRIORITY

The present invention claims priority to U.S. Provisional Patent Application No. 60/979,849 filed Oct. 14, 2007.

### FIELD OF THE INVENTION

The present invention relates generally to a system and method for implementing radio transceivers and more particularly to radio transceivers manufactured in silicon integrated circuit technology. Still more particularly, the present invention relates to a system and method for implementing a direct conversion transceiver on a single integrated circuit using silicon technology. Furthermore, the present invention relates to a single integrated circuit W-band transceiver.

### BACKGROUND OF THE INVENTION

A radio frequency transceiver generally consists of a transmitter and receiver. The transmitter, often comprised of a power amplifier (PA) and a specific type of electromagnetic signal source known as a voltage controlled oscillator (VCO), may be operable to generate high frequency electromagnetic radiation that is then reflected from objects around the transmitter. The receiver, located alongside the transmitter, is generally comprised of a low noise amplifier (LNA) and a down-conversion mixer, and amplifies the reflected high frequency electromagnetic radiation and mixes (multiplies) it with the original transmitted signal. The result of the mixing operation may be a base band (low frequency) signal that contains information about frequency or phase shifts between the reflected electromagnetic radiation received by the receiver and the original electromagnetic radiation generated by the transmitter. The frequency and phase shift information can be processed to determine the position and relative velocity of objects located around the transmitter and receiver.

Radio frequency transceivers may be used in a variety of applications including Doppler radar systems and mm-wave imaging applications due to their applicability to sense position and velocity of objects. Doppler radar transceivers are generally operable to detect very small changes in frequency for slow moving objects, which may present design challenges at high frequencies. Prior art Doppler radar transceivers have been designed for applications including airport security, biomedical imaging, and weather radar. Today, automotive applications are of interest because they represent a large market opportunity. In automotive applications, Doppler radar is used to monitor the vehicle surroundings and to alert the driver or activate other vehicle systems. Automotive applications of Doppler radar include collision avoidance (preventive detection of a vehicle ahead, for example), pre-collision intelligence (detection of an inevitable collision resulting in tightening seatbelts and deploying airbags in advance of impact, for example), lane changing assistance (detection of a vehicle in a driver's blind spot, for example), parking assistance (monitoring distance to the curb and adjacent vehicles, for example), road surface monitoring (monitoring of snow, rain or ice, for example), night and fog vision systems (detection of objects further away than can be seen by the naked eye, for example), and others. A W-band transceiver is especially useful for implementation of a Doppler radar system for automotive applications, as the frequency range allocated to automotive applications falls within the W-band.

Alternative technologies used to monitor vehicle surroundings include optical systems. However, optical systems generally do not perform well at night, or in fog, mist, or snow, or when they become dirty because these conditions block the optical signal whereas they do not greatly affect electromagnetic signals in the millimeter-wave band (30-300 GHz).

The frequency spectrum known as W-band is known to range from 75 GHz to 110 GHz. Direct conversion W-band transceivers are not known to have been implemented on a single integrated circuit (“chip”) based in silicon technology. Silicon technology (1) is lower cost than alternative technologies, and (2) along with novel design techniques that will become apparent later, enable the transceiver to be generally smaller than a similar transceiver designed in any alternative technology. The implementation and production of a single chip direct conversion W-band transceiver in silicon has not been successful in accordance with the prior art due to challenges in implementing an efficient design.

While successful construction of W-band transceivers from individual integrated circuit (IC) components is commonly seen in prior art, single chip W-band transceivers are not known in the prior art. Primarily, isolation of individual circuit blocks in a single chip transceiver may be critical, and means for implementing such isolation is not known in accordance with the prior art. For example, noise from the power amplifier may leak through common power and bias signals toward the LNA or the equivalent thereof. In contrast, when a transceiver is constructed from many individual chips, each with a single circuit block, air gaps between the chips may provide the necessary isolation. Additionally, providing power, bias, and control signals to an individual circuit component on its own chip may be a relatively straightforward task because (1) each chip is small and consumes a fraction of the power of an entire transceiver and therefore the parasitic resistances in the power, bias, and control signal routing may be negligible; (2) any method used to provide the power, bias, and control signals to the separate circuit blocks may not be simultaneously required to provide isolation between circuit blocks on separate chips; and (3) an entirely on-chip method of distributing the VCO signal to the down-conversion mixer, frequency divider, and power amplifier may not be, required. Additionally, in contrast to the high supply voltages used in most of the published transmitters and receivers, problems (1) through (3) become particularly significant when the supply voltage is largely limited to 2.5V.

Furthermore, silicon technology generally offers lower performance (i.e. lower f_{T} and f_{MAX} values) than competing technologies, and therefore designing such a transceiver in silicon at W-band is generally difficult. Silicon transistors (SiGe HBTs or standard CMOS) fast enough to allow circuits to operate reliably at W-band have only become available recently. Additionally SiGe HBT behavior is not completely understood within the W-band. Particularly, greater understanding of the performance of these devices at varying temperatures is needed to design robust radar transceivers for commercial and industrial applications, where the temperature may vary from −50° C. to +125° C. SiGe HBT models available to circuit designers are not always accurate, which may lead to discrepancies between simulations and measurements that make designing many circuits to work together simultaneously particularly challenging. Obtaining accurate information about the behavior of SiGe HBTs may require a combination of advanced measurement equipment, knowledge of how to measure the HBTs, and accurate de-embedding of the effects of the test equipment. This combination of skills and equipment is available at only a few laboratories worldwide.

A direct conversion architecture generally contains fewer components and therefore may be more reliable and consume less power than a heterodyne architecture. However, a direct conversion architecture may be subject to disadvantages especially to when implemented on a single die, including primarily leakage of the transmitter signal directly into the receiver.

One advantage of a direct conversion architecture is its simplicity, which may translate directly into fewer transistors and circuit blocks, which in turn results in lower power consumption, higher reliability, and smaller die area in integrated implementations. The chief disadvantages of the direct conversion architecture are (1) that the PA can easily influence the frequency of the VCO because they both operate at the same frequency (f_{LO}); (2) the VCO needs generally good close-in phase noise performance (to detect small Doppler shifts); and (3) down-conversion to baseband (zero IF) can lead to increased flicker noise when compared with low-IF transceivers. These disadvantages have prevented those skilled in the art from realizing that a direct conversion architecture could successfully operate as a Doppler radar transceiver and therefore development efforts have been spent on systems that rely on other architectures.

For example, all three disadvantages of the direct conversion architecture can be avoided using a low-IF heterodyne architecture. An up-converter in the transmitter allows the VCO and the PA to operate at different frequencies, and phase-noise and flicker-noise are avoided with the correct choice of IF. However, one disadvantage of the heterodyne architecture is that the Doppler shift (Δf₁), which is usually very small, may be more difficult to determine at an accuracy achievable by the direct conversion architecture, for various reasons including the introduction of phase noise not present in the direct conversion architecture. It is therefore preferable that the single chip direct conversion W-band transceiver employs the direct conversion architecture.

From a system perspective, the receiver and the transmitter are preferably isolated from each other to avoid leakage of the transmitter output signal through the substrate or shared power and ground signals and into the receiver (isolation is a particular concern in the direct conversion architecture). Although some isolation techniques are known, there has so far been an inability to implement these into a complex transceiver with many circuit blocks. Thus there is a need for a systematic method of implementing isolation structures and techniques for application consistently throughout a chip. This is one reason that most attempts to develop a W-band transceiver in silicon rely on separate receiver and transmitter chips. However, in a Doppler radar system, the transmitter and the receiver may require a common VCO signal, which must then be routed from the transmitter chip to the receiver chip. This is generally a very demanding task above 75 GHz.

Additionally, prior art transmitters, receivers, and transceivers in the W-band generally require higher supply voltages (3.5V and higher), which means a greater number of transistors can be stacked between the supplies, and greater voltage swing is possible. Obtaining a W-band transceiver at a lower supply voltage means lower power consumption, and that, ultimately, multiple transceivers can be located together on the same die with the same power consumption as a single receiver or transmitter of the prior art.

When many circuit blocks are integrated together on the same die, the power consumption of each circuit block optimally is minimized. To accomplish this power reduction, novel circuit topologies may be required to allow low-voltage operation, or existing topologies are preferably modified or designed differently to allow their use in W-band.

Thirdly, in a transceiver, the local oscillator (LO) signal from the VCO is generally distributed to circuit blocks in the receiver (the down-conversion mixer) and in the transmitter (the power amplifier and frequency divider). Although routing a W-band frequency signal across the chip may be easier in some respects than routing it between chips, such an implementation may introduce new problems that may not exist when routing the signal between chips. These new problems have prevented the routing of a W-band frequency signal across a chip in the prior art. Also difficult is designing a VCO with sufficient output power to drive these multiple circuit blocks. Methods of clock distribution at lower frequencies are well-known, as are techniques for designing VCOs with high output power. However, these technologies generally required modification for use in W-band.

Finally, previous silicon based W-band transmitters and receivers often incorporate a frequency divider. These dividers may be dynamic dividers, such as Miller dividers or injection locked dividers, which have narrower operable frequency ranges than a static divider. The choice of a dynamic frequency divider over a static frequency divider is generally made because the dynamic frequency divider requires much less power to successfully perform frequency division, and therefore can be easily designed to present minimal load to the VCO. Dynamic dividers are also generally operable at higher frequency than static dividers, and therefore can be more easily designed to successfully divide W-band VCO signals.

However, there is a significant disadvantage to the use of a dynamic frequency divider in place of a static frequency divider. The VCO and frequency divider must be designed to operate in the same frequency range. For example, if the VCO and divider both have the identical 2 GHz frequency range (77-79 GHz) the chances that the two will work together are relatively small. When the temperature changes, for example, the VCO might shift down to 76-78 GHz, and the divider down to 73-75 GHz. In such a case the divider fails to divide the VCO signal. It is preferable to incorporate a divider with a much higher frequency range such that it may be operable for any reasonable shift in the VCO's frequency. A static frequency divider is generally operable over a much larger frequency range than a dynamic frequency divider.

For automotive applications in particular all of the design challenges listed thus far must be overcome with sufficient design margin to allow robust operation up to 125° C.

Doppler radars have been described in the prior art.

In [1] a transceiver module at 76-77 GHz useful in automotive applications employing Gallium Arsenide (GaAs) discrete components is described. The cost of this system remains large because GaAs components are used instead of silicon components. The use of discrete components in results in a device that is physically large (20×22×8 mm) relative to the size of the same device if it were fully integrated onto a silicon substrate.

In [2] a fully integrated Doppler radar transceiver at 65 GHz is implemented in silicon, however 65 GHz is not a frequency licensed for automotive applications. Adapting this transceiver to 77 GHz operation is non-trivial. Additionally, 65 GHz is highly absorbed by oxygen in the atmosphere, making it difficult to detect far away objects. No frequency divider is provided.

In [3] and [4], a phased array consisting of four heterodyne 77 GHz transmitters and four 77 GHz receivers is also described. The system uses down-conversion or up-conversion of a 26 GHz intermediate frequency (IF) signal to 77 GHz. The system is not a direct conversion transceiver and cannot detect Doppler shift for a variety of reasons apparent to those skilled in the art.

In [5] a spread spectrum transmitter at 79 GHz for automotive applications is disclosed. However, the receiver is located on a different chip necessitating off-chip routing of the VCO signal from the transmitter to the receiver.

In [6] is a transceiver for simultaneous 80 GHz and 160 GHz operation. The transmitter (directly from the VCO) provides 80 GHz and 160 GHz outputs. The receiver uses a 160 GHz down-conversion mixer, which operates as a sub-harmonic mixer if the received signal is at 80 GHz. The described transceiver is missing a low-noise amplifier at the receiver, and a power amplifier at the transmitter, and does not include a frequency divider. This lower level of integration greatly simplifies the design effort required.

U.S. Pat. No. 7,224,722 to Shi et al. discloses a direct conversion RF transceiver with automatic frequency control. The invention relates to wireless communications, which generally operate under 2 GHz.

U.S. Pat. No. 5,953,640 to Meador et al. discloses a configuration single chip receiver integrated circuit architecture. The invention is operable in the frequency range from 40 MHz to 600 MHz.

U.S. Pat. No. 6,477,148 to Gardenfors et al. discloses a radio transceiver on a chip. The transceiver uses the heterodyne architecture.

U.S. Pat. No. 7,065,327 to Macnally et al. discloses a single-chip CMOS direct-conversion transceiver. The invention relates to wireless communications, which generally operate under 2 GHz.

In view of the foregoing, what is needed is a low cost, single chip direct conversion W-band transceiver in silicon technology.

### SUMMARY OF THE INVENTION

In a first aspect of the present invention, a direct conversion radio frequency (RF) transceiver integrated circuit is provided, the direct conversion radio frequency (RF) transceiver integrated circuit comprising: (a) a local oscillator that generates an RF local oscillation signal; (b) a receiver section operably coupled to the local oscillator to receive the RF signal, wherein the receiver section receives an incoming RF signal, and wherein the receiver section down-converts the incoming RF signal based upon the RF local oscillation signal to produce an incoming baseband signal; and (c) a transmitter section operably coupled to the local oscillator, wherein the transmitter receives the RF local oscillation signal, and wherein the transmitter section amplifies the RF local oscillation signal with a gain of at least one to produce an outgoing RF signal; wherein the local oscillator, the receiver section, and the transmitter section all reside on a common silicon-based integrated circuit.

In another aspect of the present invention, a clock distribution system operable to distribute a clock signal to a plurality of circuit blocks is provided, the system comprising: (a) a local oscillator that generates an RF local oscillation signal; (b) a clock buffer operably coupled to the local oscillator; (c) a plurality of buffers, each said buffer operably coupled to the clock buffer; and (d) a plurality of circuit blocks, each said circuit block operably connected to one of the buffers; wherein said RF local oscillation signal is at a frequency ranging from 75 GHz to 110 GHz.

In a still other aspect of the present invention, a clock distribution system operable to distribute a clock signal to a plurality of circuit blocks is provided, the system comprising: (a) a local oscillator that generates an RF local oscillation signal; (b) a clock transmission line operably coupled to the local oscillator; (c) a plurality of transmission lines, each transmission line operably coupled to the clock transmission line buffer; and (d) a plurality of circuit blocks, each said circuit block operably connected to one of the transmission lines; wherein said RF local oscillation signal is at a frequency ranging from 75 GHz to 110 GHz.

In yet another aspect of the present invention, a method for radio detection and ranging (RADAR) using a Doppler RADAR transceiver system operable at a transmission frequency ranging from 75 GHz to 110 GHz is provided, the method comprising: (a) generating an RF local oscillation signal; (b) coupling the RF local oscillation signal to a transmitter, said transmitter operable to transmit the RF local oscillation signal; (c) receiving a reflection of the RF local oscillation signal at a receiver operable to receive an RF signal; (d) multiplying said reflected version of the RF local oscillation signal by the RF local oscillation signal; and (e) establishing a low frequency component of the multiplication.

In another aspect of the present invention, a method for noise isolation among a plurality of circuit blocks connected to a metal plane is provided, the method comprising: (a) providing air gaps located in between each section of the metal plane located adjacent to each of a plurality of circuit blocks; and (b) connecting each section of the metal plane to an adjacent section of the metal plane at a location on the edge of the metal plane corresponding to a point equidistant from the two sections of the metal plane, wherein the point occupies a portion of the metal no smaller than required for a connection point for a power or control signal.

In a further aspect of the present invention, a method for noise isolation among a plurality of adjacent metal planes on a single integrated circuit die is provided, the method comprising providing a plurality of holes located in a grid on each said metal plane, wherein two adjacent metal planes define an upper metal plane and a lower metal plane, such upper metal plane and lower metal plane being aligned such that the square shaped holes of the upper metal plane positioned substantially above the holes of the lower metal plane.

### BRIEF DESCRIPTION OF THE DRAWINGS

FIG. 1 illustrates a direct conversion transceiver architecture in accordance with the invention.

FIG. 2 illustrates a block diagram of an implementation of the W-band Doppler radar transceiver.

FIG. 3 illustrates a scalable integrated circuit layout technique to minimize noise in an integrated circuit.

FIG. 4 illustrates a technique by which the technique illustrated in FIG. 3 becomes scalable to multiple metal layers.

FIG. 5 illustrates a process by which the technique illustrated in FIG. 3 may be modified.

FIG. 6 illustrates the result of implementing the technique illustrated in FIG. 3 across an integrated circuit.

FIG. 7 illustrates a technique to reduce noise among circuit blocks in an integrated circuit.

FIG. 8 illustrates yet another technique to reduce noise among circuit blocks in an integrated circuit.

FIG. 9 illustrates a technique to combine the techniques illustrated in FIGS. 7 and 8 to further reduce electrical interference.

FIG. 10 illustrates a process by which circuit blocks and signals are isolated, providing for a low noise design, allowing the transmitter and receiver to be placed on a single chip.

FIG. 11 illustrates correlation of the LO and RF signals at the LO and RF inputs of the down-conversion mixer.

FIG. 12 illustrates two methods of signal splitting in a clock tree.

### DETAILED DESCRIPTION

### Overview

The present invention discloses a system and method for implementing a single chip direct conversion W-band transceiver in silicon. The present invention also discloses a system and method for providing a clock distribution architecture operable to distribute a W-band signal in silicon technology. The present invention enables the die area of a transceiver to be minimized and power consumption to be reduced, using these systems and methods.

The invention is advantageous over prior art systems in that it provides a W-band transceiver that is fully integrated onto a single chip in silicon technology. Another aspect of the present invention is a novel W-band single chip transceiver.

From a system perspective, the receiver and the transmitter are isolated from each other to avoid leakage of the transmitter output signal through a substrate or shared power and ground signals and into the receiver (isolation is a particular concern in the direct conversion architecture). The present invention includes a systematic method for implementing isolation structures and techniques consistently throughout the chip.

A further advantage is that the present invention overcomes the leakage problem previously preventing implementation of a single die direct conversion W-band transceiver by using novel isolation structures and techniques between the transmitter and receiver.

Another advantage is that the invention uses standard 3.3V (for the frequency divider) and 1.8V/2.5V (for the transmitter and receiver) power supplies, which reduces system power consumption.

Yet another advantage of the present invention is the use of a static frequency divider that provides a wider division frequency range than other types of frequency dividers and therefore is more reliable over temperature and manufacturing variations.

A further advantage of the present invention is its low manufacturing cost as, it is implemented in silicon, and requires considerably less die area than other state-of-the-art transmitters, receivers, and transceivers.

Additional objects, advantages, and novel features of the invention will be set forth in part in the description and drawings which follow, and in part will become apparent to those skilled in the art upon examination of the following or may be learned by practice of the invention. The objects and advantages of the invention may be realized and attained by means of the instrumentalities and combinations particularly pointed out in the appended claims.

### Direct Conversion Transceiver

The direct conversion transceiver contains all blocks required for the transceiver functionality described (in one implementation thereof, for example, a VCO, an LNA, a PA, a mixer, and a static frequency divider). These components enable fabrication of a fully integrated low voltage, W-band transceiver with phase locked loop (PLL).

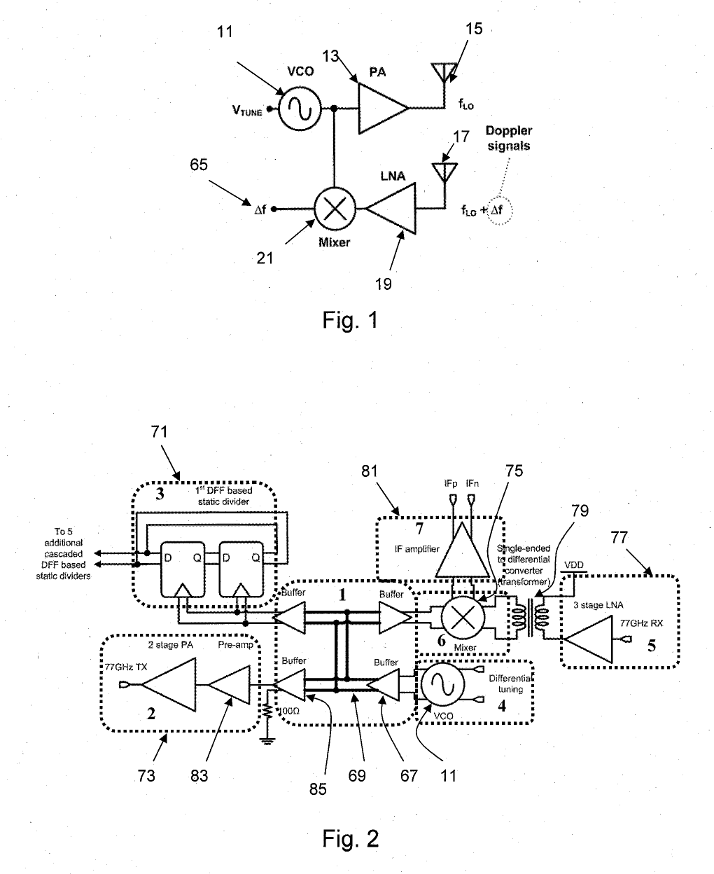

FIG. 1 illustrates a block diagram of a direct conversion transceiver in accordance with the present invention. A particular embodiment of a direct conversion transceiver of the present invention is illustrated in FIG. 2. It is apparent to those skilled in the art that other embodiments of a direct conversion transceiver would provide substantially similar results, while leveraging the system, method and architecture of the present invention. Some other particular implementations of the present invention and embodiments are described below.

Generally, the direct conversion transceiver is operable as follows, in accordance with one embodiment thereof. The voltage-controlled oscillator (VCO) (11) may generate a radio frequency signal that is amplified by the power amplifier (PA) (13). The signal at the output of the PA (13) may optimally be transmitted using an antenna (15). The transmitted signal may reflect off of an object a distance away from the transmitting antenna (15) back to a receiving antenna (17). The received signal is amplified by a low-noise amplifier (LNA) (19) which is coupled to the mixer (21), which mixes (multiplies) the received signal with the signal generated by the VCO (11). The resulting mixed signal contains a high frequency component that is filtered out in the electronics as well as a baseband signal that represents the Doppler shift. An on-chip intermediate frequency (IF) amplifier (not shown) provides additional gain at baseband and can drive off-chip test equipment.

### W-Band Transceiver in Silicon Technology Using a Direct Conversion Architecture

The present invention overcomes the obstacles previously mentioned that prevent the implementation of a single chip direct conversion W-band transceiver in silicon. More particularly, the present invention overcomes the chief concerns of the direct conversion transceiver which are (1) isolation of circuit blocks, (2) flicker noise at baseband, and (3) VCO phase noise.

### Noise Isolation Using a Novel Integrated Circuit Design Methodology

The present invention discloses a cell based integrated circuit layout methodology that may provide isolation between adjacent circuit blocks along with high capacitance and low resistance and low inductance power, ground, and bias planes for multiple circuit blocks. Simultaneously, the methodology may allow the circuit designer flexibility in both the routing of signals over, under or between metal planes, and in choosing which of the stacked metal layers commonly provided in the back-end-of-line (BEOL) are connected together, and which are not. Additionally, the methodology may enable the designer to meet density rules on all layers without relying on computerized filling algorithms. Finally, the methodology may allow the designer to easily insert into an existing layout circuit blocks and components with minimal modifications to any layout work already performed.

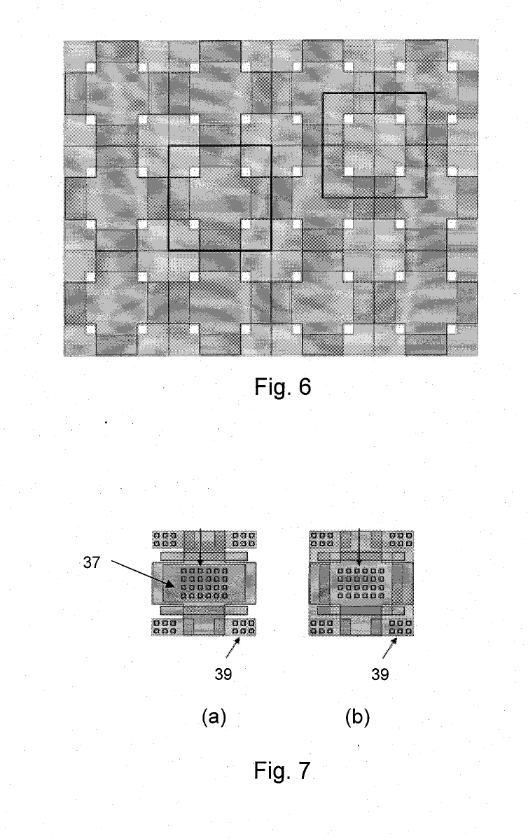

FIG. 6 illustrates a novel methodology of arranging metal planes in a mesh pattern. The mesh covers all unused area on-chip, and is designed to provide the maximum coverage allowed by design rules (which may typically range from 70% to 80%). Furthermore, the mesh may provide substrate contacts and is highly capacitive, which offers significant decoupling. Decoupling capacitors may also be inserted into the mesh periodically, particularly near circuits. Various sizes of decoupling capacitors may be used to provide decoupling at different frequencies. The mesh meets density requirements on active, poly, and all metal and via layers which simplifies chip finishing procedures.

Although efforts are made to minimize the mesh resistance, considerable resistance could be present in circuits that are far away from ground or power pads. Decoupling capacitors may be placed immediately at the end of all inductors and transmission lines to improve the AC ground.

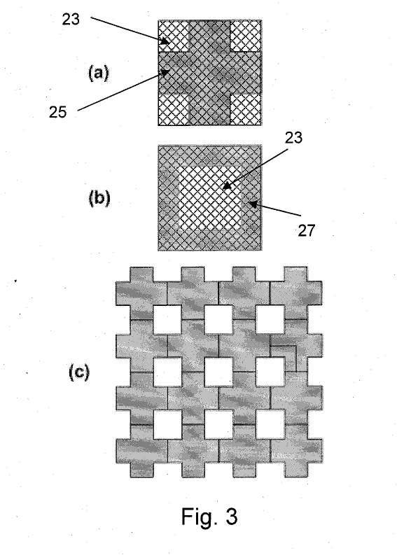

FIG. 3a illustrates a square (23) of area A that may be filled to an arbitrary density by the plus shape (25) of area B. The density of fill may then be B/A. Alternatively, the same density of B/A may be obtained by filling the square (23) with the hollow-square shape (27) of FIG. 3b. If either pattern illustrated in FIGS. 3a and 3b is repeated, as shown in FIG. 3c for example, the total area filled with the pattern is filled to the density B/A. A plane of metal with density B/A may be created over a large area of an integrated circuit layout simply by repeating the cell in a mosaic if the area B is a layout cell containing a piece of metal, as illustrated in FIG. 3c.

The density B/A may optimally be chosen to be slightly less than the maximum allowable density the metal layer in the BEOL of the technology used. Thus, the area filled with the metal plane may have the minimum possible resistance between any two points on it, yet may pass the density fill rules on the metal within the area of fill. No computerized fill algorithm may be required.

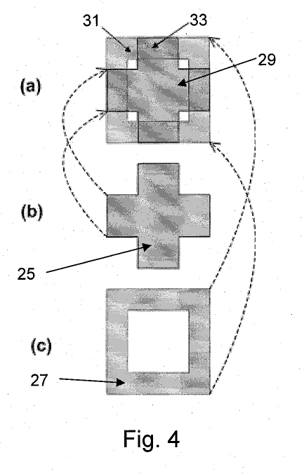

FIG. 4 illustrates an arrangement of multiple metal layers that may be implemented using this technique. If the plus shape (25) illustrated in FIG. 4b is considered to be a piece of metal 1, and the hollow-square shape (27) illustrated in FIG. 4c is considered to be a piece of metal 2, then when they are overlapped in the layout view, 3 distinct regions may be formed: (1) regions where only metal 1 may be present (29), (2) regions where only metal 2 may be present (31), and (3) regions where metal 1 and metal 2 may overlap (33). The three types of regions (29, 31, 33) may be used to connect stacked metals in almost arbitrary combination by choosing which metals are formed using a plus shape (25) and which are formed using a hollow-square shape (27).

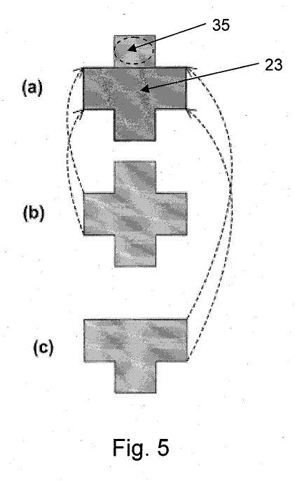

As illustrated in FIG. 5a, one or more of the tabs (35) of a plus shape (25) may be removed, which may create additional regions where some plus shapes overlap but others do not. This may allow the circuit designer to connect stacked metals almost arbitrarily without relying on the hollow-square shape (27). By utilizing pieces of metal of the hollow-square shape (27) and the plus shape (25), which may or may not comprise all four tabs (35), the circuit designer may gain a systematic freedom in stacking and connecting metals. When shapes are repeated in a regular pattern, as shown in FIG. 6, the different types of overlapping regions may be preserved, whereas anything underneath the pattern may be almost entirely hidden. The region underneath the pattern in an integrated circuit may be the silicon substrate. Therefore, by arranging two or more stacked metals in the fashion of FIG. 6, the circuit designer may obscure the substrate from transmission lines and interconnects on higher metal layers.

FIG. 6 also illustrates that when implemented across a metal plane, the plus shape (25) and hollow-square shape (27) may be indistinguishable. It should also be noted that other combinations of shapes may exist that may accomplish the same or a similar outcome. Such a shape may comprise a polygon shape such as a hexagon shape, for example.

### Isolation of Circuit Blocks

On-chip leakage between circuit blocks may have two primary pathways: the substrate, and shared power and bias planes including the ground plane. Substrate leakage may be reduced by placing n-well and p-sub contacts between circuit blocks. For isolation at mm-wave frequencies, a pattern of small checkered n-well and p-sub regions may be preferred over a continuous n-well region. Noisy power signals, such as the PA supply, may optimally have minimal contact to the substrate.

A novel approach to isolate circuit blocks on integrated circuits incorporates printed circuit board (PCB) design methodologies. Leakage through power and bias planes may be reduced. Power, bias, and ground planes must be maximally capacitive, minimally inductive and resistive, and separate (or at least split) for circuit blocks that must be isolated.

In the single chip direct conversion W-band transceiver, separate power supply domains may be used for the LNA, PA, and digital (divider) circuitry on-chip.

Isolation of circuit blocks located on the same die may normally be achieved by creating distance between them. However, placing circuit blocks further apart may increase the chip area and therefore also may increase its cost. Instead, the circuit blocks of the present invention may be isolated using two techniques. First, isolation structures may be placed between them. Second, metal planes may be stacked.

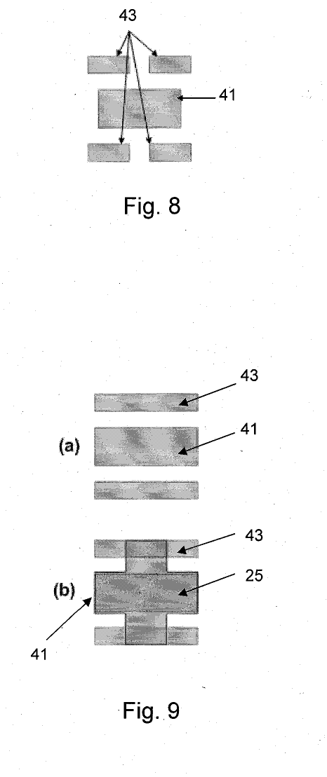

FIG. 7 illustrates that the isolation structures may consist of a stack of metal layers (37, 39) optionally connected to either a plurality of power, ground, and bias signals; all connected to ground; or all connected to power. As illustrated in FIG. 8, the isolation structures may also consist of a checker pattern of p-sub (41) and n-well (43) regions connected to ground. The n-well (n-type) (43) and p-well (p-type) (41) regions may ensure that noise generated by one circuit block may not easily travel through the substrate to another circuit block while the stacked, grounded metals form a Faraday cage around each circuit block that may shield it from electromagnetic fields generated by other blocks.

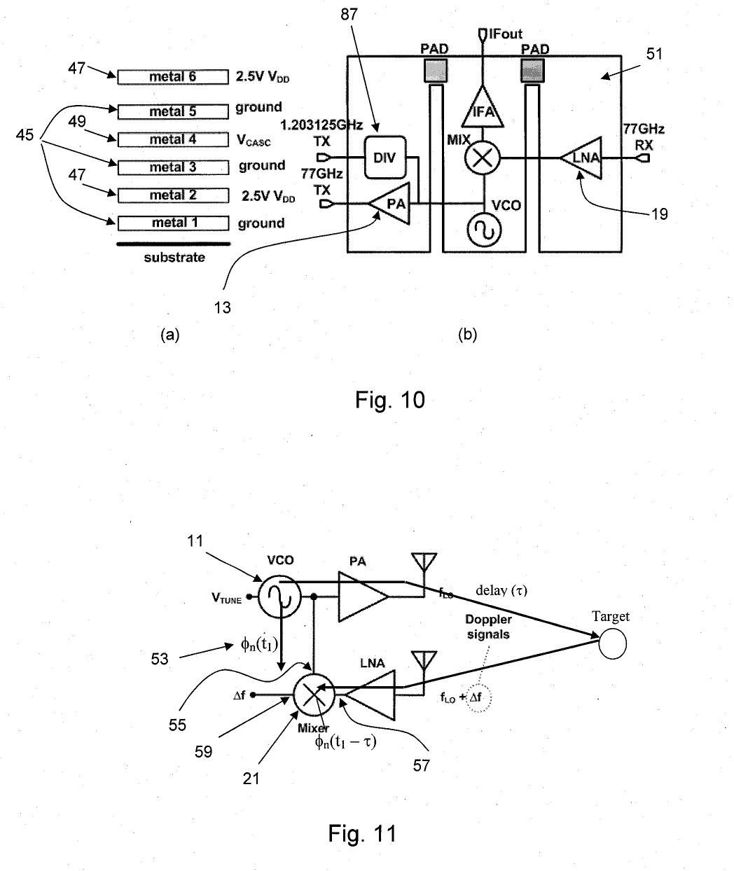

FIG. 9 illustrates a pattern that may be used to provide substrate isolation among circuit blocks. The n-well (43) and p-well (41) regions described above may be arranged within a square of area A, which may be equivalent to the area occupied by a unit of metal as described earlier, as illustrated in FIG. 9b. Areas of overlap between the piece of metal (25) and the n-well (43) and p-well (41) regions may be used to form connections between them. FIGS. 10 and 11 illustrate how the n-well and p-well regions may be repeated in a mosaic to isolate areas of the substrate. For example, in FIG. 8, substrate noise may be reduced since noise traveling from point A to point B must take a circuitous route that impedes its travel.

Further isolation may be achieved using highly capacitive stacked metal planes to distribute ground, power, and bias signals to all circuit blocks. As shown in FIG. 10a, the metal planes may be stacked to provide as much capacitance between the ground plane (45) and metal planes of other power (47) and bias (49) signals. As shown in FIG. 10b, the metal planes (51) used to distribute said signals to noisy circuit blocks, such as the PA (13) for example, may be separated from the metal planes used to distribute said signals to sensitive circuit blocks, such as the LNA (19) for example. Noise generated by the PA (13) may not travel directly to the LNA (19), but may take a longer route and therefore may be highly attenuated by the time it reaches the LNA (19).

### Minimizing Flicker Noise at Baseband

The present invention may be operable to overcome flicker noise problems by optionally implementing the circuit in SiGe HBT, for which flicker noise at baseband is minimal.

### Minimizing VCO Phase Noise

VCO phase noise may present a problem in Doppler radar systems because it limits both the smallest Doppler frequency that can be detected and also the useful range of the Doppler radar. The VCO phase noise must therefore be minimized. Because VCO phase noise performance degrades as the oscillation frequency of the VCO increases, state-of-the-art silicon W-Band transmitters often use a lower frequency VCO to obtain superior phase noise performance. Those skilled in the art generally believe the phase noise performance of W-band SiGe HBT VCO may not be sufficient to detect Doppler shifts on the order of tens or hundreds of hertz. However, using a lower frequency VCO may necessitate the use of an up-converter or frequency multiplier to obtain a W-Band signal. The present invention employs two novel techniques to overcome this issue.

First, the VCO in the present invention may achieve low phase noise by implementing the VCO as a differential Colpitts oscillator. The oscillator may use a single transistor topology to minimize phase noise. The use of this VCO at 77 GHz, for example, may be operable to detect a Doppler shift of only 55 Hz.

Second, phase noise may be reduced in the direct conversion architecture by correlation at the LO and RF ports of the down-conversion mixer. As illustrated in FIG. 11, in a direct conversion receiver the phase noise, φₙ (t₁)(53), present at the LO port (55) of the mixer is produced by the same VCO (11) (as there is only one VCO) as the phase noise received at the RF port (57) of the mixer. However, due to the round trip delay time (τ) to the target, the phase noise present at the LO port (55) is then a time delayed version of the noise seen at the RF port (57), or φₙ(t₁−τ). For small values of τ, the phase noises X and Y are highly correlated, and therefore the phase noise at the baseband output (59) of the mixer (21) is reduced.

### Clock Distribution

Implementing a W-Band transceiver may require that a single VCO provide signals for at least three circuit blocks, if present in the direct conversion transceiver: the power amplifier, down-conversion mixer, and frequency divider. The VCO must provide sufficient signal power to each block such that they all function correctly.

Connecting the VCO directly to all circuit blocks may result in a non-functional transceiver, or at best a transceiver with significantly reduced performance because the down-conversion mixer, frequency divider and power amplifier together present a significant load that the VCO cannot drive directly. Furthermore, noise generated by the power amplifier can then leak backward through its connection to the VCO, and into the VCO, from where it can propagate directly to the down-conversion mixer and subsequently the LNA. Noise generated by the frequency divider may propagate similarly. A clock distribution network is needed to provide high forward gain from the VCO to the down-conversion mixer, power amplifier and frequency divider while (1) simultaneously providing high reverse attenuation to prevent the back-propagation of noise from the power amplifier and frequency divider into the VCO and down-conversion receiver; and (2) allowing some physical separation of the VCO, power amplifier, frequency divider, and down-conversion mixer wherein isolation structures can be inserted to further prevent the propagation of noise between circuit blocks, and power, bias, and control signals can be routed.

One method for VCO signal distribution is called a clock tree.

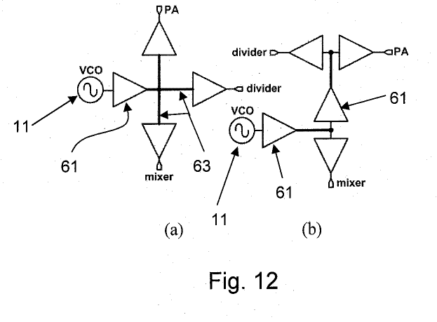

A clock tree is an expanding series of buffers (61) and transmission lines (63) that splits the VCO signal into several separate signals, as shown in FIG. 12a, where the signal splitting is accomplished using transmission lines. Alternatively, as shown in FIG. 12b, the signal splitting can be implemented using the buffers themselves.

The buffers (61) in the clock tree may amplify the VCO signal to drive the various circuit blocks. A single VCO (11) may not be operable to drive each circuit block without the use of the clock tree.

The clock tree may also allow a W-band VCO signal to be routed between circuit blocks, which allows sensitive receiver circuits, such as the LNA, to be separated far from the power amplifier and the isolation structures described earlier to be placed between.

### Static Frequency Divider

Another aspect of the present invention is that it implements a W-band static frequency divider in a silicon based W-band transceiver. The static frequency divider may provide an output at some fraction of the VCO frequency (one 64^{th} for example), a signal operable in a phase-locked loop. The static frequency divider architecture offers a wider division frequency range than other types of frequency dividers (for example, dynamic frequency dividers) and therefore is more reliable over temperature and manufacturing variations.

A static divider topology is, however, difficult to design from a 3.3V supply with sufficient design margin for use up to 125° C. in W-band.

The implementation of the static frequency divider of the present invention is enabled by the clock distribution technique. While a static frequency divider driven directly from the VCO may not be operable, the buffers in the present invention amplify the VCO signal so that the divider is operable.

Furthermore, the self-oscillation frequency of the static divider may be designed to be the same as the VCO oscillation frequency. This technique may further reduce the input power requirements of the static frequency divider.

### Embodiments

The frequency band of 77-81 GHz has been designated for automotive use and therefore a W-band transceiver that operates within this narrower frequency band could be used in automotive applications.

FIG. 1 illustrates a direct conversion transceiver. The Doppler shift due to a moving target is indicated by a frequency shift Δf (65) in the reflected LO signal.

A single-chip silicon direct-conversion transceiver may contain four core components: low-noise amplifier (LNA) (19), voltage-controlled oscillator (VCO) (11), power amplifier (PA) (13), and down-conversion mixer (21), arranged as illustrated in FIG. 1, and fabricated together on the same silicon substrate.

One embodiment of a single chip direct conversion transceiver is illustrated in FIG. 2. In this embodiment, the voltage-controlled oscillator (VCO) (11) may drive a single buffer (67), which may drive a network of transmission lines (69) that may distribute the signal to the 6-stage static frequency divider (divider) (71) the three stage power amplifier (PA) (73) and the down-conversion mixer (Mixer) (75). The received signal may be amplified by a three stage low-noise amplifier (LNA) (77), which may be transformer coupled (79) to the mixer (75). An on-chip intermediate frequency (IF) amplifier (81) may provide additional gain at baseband and may drive off-chip test equipment. The transceiver may be physically implemented to occupy an area of approximately 1.2 mm by 0.9 mm, including all pads.

A frequency divider may be added, as described above, to facilitate the development of systems, such as automotive radar, that may require additional circuitry relying on a divided version of the VCO signal. The additional circuitry may be, for example, a phase locked loop (PLL). Yet more circuitry may be located on the chip, such as digital signal processing (DSP) circuitry, voltage regulators and references, analog to digital converters, or an intermediate frequency (IF) amplifier.

Furthermore, some of the four core circuit blocks may be removed, albeit at a significant performance cost. For example, the LNA (77) and PA (73) may be removed, however then the system would suffer from poor noise performance as the first circuit to receive the reflected signal would be the down-conversion mixer, and mixers typically may have higher noise figure (NF) than amplifiers. Alternatively, only the PA (73) may be removed, and the VCO (11) may be used as the transmitter directly. Without a PA (73), however, the usable range of the transceiver would be greatly reduced. As yet another alternative, the PA (73) may be made smaller (which reduces the transmitted power), and the gain of the LNA (77) increased, such that the overall performance of the transceiver is unaffected. Likewise, the PA (73) may be made larger (which increases the transmitted power), and the gain of the LNA (77) decreased. Furthermore, both the LNA (77) and PA (73) may be removed, and the system would remain a single-chip direct-conversion transceiver because it maintains the fundamental property that frequency conversion from RF to baseband is completed in a single step, and on a single chip. Further still, the transceiver may be implemented without the transformer (79) coupling the LNA (77) to the mixer (75).

There may be further modifications to the PA (73). The PA (73) may be implemented without a pre-amplifier (83). Additionally, the PA (73) may be driven differentially by the VCO clock tree buffer (85) corresponding to the PA (73). Furthermore, the PA (73) may be combined in parallel with additional PAs to deliver more output power.

The LNA (77) may be modified to contain a variable attenuator.

The IF amplifier (81) may be removed.

The VCO (11) may be further modified. The VCO (11) may be operable with differential tuning or single ended tuning. Additionally, the transceiver may contain multiple VCOs of different frequency ranges to implement an overall wider frequency range. For example, there may be one VCO (11) with a frequency range of 77-79 GHz and a second VCO (11) with a frequency range of 79-81 GHz. The two VCOs may be used together to provide a transceiver operable between 77 GHz and 81 GHz.

The VCO (11) may be provided at a different frequency. Generally a system, such as the present invention, that is operable at a given frequency is also operable at all lower frequencies. Thus the VCO (11) may be operable at any frequency at or below W-band.

The single-chip silicon direct-conversion transceiver is separate from the implementation of the individual circuit components, so long as they are implemented on silicon together on the same substrate. For example, the LNA (77) or PA (73) may contain alternate numbers of stages, any circuit block may operate from a higher or lower supply voltage, or may be implemented using different circuit topologies (such as differential topologies, for example) than those used in the embodiment illustrated in FIG. 2. Furthermore, the direct conversion transceiver is independent of the performance of each circuit block. For example, the LNA (77) may have more gain or improved noise figure, the PA (73) may provide greater output power, and the VCO (11) may have lower phase-noise. Finally, individual circuit blocks, or groups of circuit blocks (such as the LNA (73) and mixer (75), for example) may contain novel or non-obvious improvements or modifications, but still be arranged to form a direct conversion transceiver.

Other embodiments of the invention may be formed by connecting the circuit blocks together in a different manner.

Isolation techniques may also be modified. The metal planes (51) as shown in FIG. 10b may be provided with greater separation such that any of the components, or each component, shown in FIG. 10b is isolated from the others. For example, the PA (13) may be physically separated from the frequency divider (87) shown in FIG. 10b.

The clock distribution network may be modified. There may be provided more or less number of transmission lines (63) or buffer amplifiers (61) to drive the circuit blocks. Furthermore, the clock distribution network may be removed and the VCO (11) may drive the mixer (75), divider (71) and PA (73) directly.

The static frequency divider (71) may be provided with a different number of stages or a different division rate.

### Implementation

The single chip direct conversion W-band transceiver may be operable to detect the Doppler shift. The use of radio-frequency transceivers for detecting the Doppler shift is known to those skilled in the art. The present invention is operable to provide a Doppler radar transceiver in the automotive frequency range of 77 GHz to 81 GHz and, therefore, is useful in the applications of collisions avoidance, pre-collision intelligence, lane-changing assistance, parking assistance, road surface monitoring, night and fog vision systems, and other applications employing Doppler shift detection.

The single chip direct conversion W-band transceiver may also be operable for mm-wave imaging. The use of radio-frequency transceivers for mm-wave imaging is known to those skilled in the art.

### Experimental Verification

Experimental verification was conducted using a 0.13 μm SiGe BiCMOS process with f_{T}/fₘₐₓ of 170/200 GHz implementing the embodiment given in FIG. 2. The selected frequency for the LO was 77 GHz.

The transceiver produced a gain over 20 dB.

Relative to prior art 77 GHz transceivers, the present invention experiences a relatively high linearity, relatively low noise, and low die area.

### CITATIONS

[1]I. Gresham et al., “A 76-77 GHz Pulsed-Doppler Radar Module for Autonomous Cruise Control Applications,” 2000 IEEE MTTS Digest, pp. 1551-1554.
[2]T. Yao et al., “65 GHz Doppler Sensor with On-Chip Antenna in 0.18 μm SiGe BiCMOS,” 2006 IEEE MTTS Digest, pp. 1493-1496.
[3]A. Babakhani et al., “A 77-GHz Phased-Array Transceiver With On-Chip Antennas in Silicon: Receiver and Antennas,” IEEE Journal of Solid-State Circuits, Vol. 41, No. 12, December 2006, pp. 2795-2806.
[4] A. Natarajan et al., “A 77-GHz Phased Array Transceiver With On-Chip Antennas in Silicon: Transmitter and Local LO-Path Phase Shifting,” IEEE Journal of Solid-State Circuits, Vol. 41, No. 12, December 2006, pp. 2807-2819.
[5] S. Trotta et al., “A 79 GHz SiGe-Bipolar Spread-Spectrum TX for Automotive Radar,” 2007 IEEE International Solid State Circuits Conference, pp. 430-431, 613.
[6] E. Laskin et al., “80/160-GHz Transceiver and 140-GHz Amplifier in SiGe Technology,” 2007 IEEE Radio Frequency Integrated Circuits Symposium, pp. 153-156.

What is claimed is:

1. A direct conversion radio frequency (RF) transceiver integrated circuit characterized by:
a. a local oscillator that generates an RF local oscillation signal;
b. a receiver section operably coupled to the local oscillator to receive the RF signal, wherein the receiver section receives an incoming RF signal, and wherein the receiver section down-converts the incoming RF signal based upon the RF local oscillation signal to produce an incoming baseband signal; and
c. a transmitter section operably coupled to the local oscillator, wherein the transmitter receives the RF local oscillation signal, and wherein the transmitter section amplifies the RF local oscillation signal with a gain of at least one to produce an outgoing RF signal
wherein the local oscillator, the receiver section, and the transmitter section all reside on a common silicon-based integrated circuit.

2. The transceiver integrated circuit of claim 1 characterized in that the RF local oscillation signal is within the frequency range of 75 GHz to 110 GHz.

3. The transceiver integrated circuit of claim 1 characterized in that the RF local oscillation signal is within the frequency range of 77 GHz to 81 GHz.

4. The transceiver integrated circuit of claim 1 characterized in that the receiver section comprises a low noise amplifier (LNA) and a mixer, said mixer operable to couple the LNA to the local oscillator.

5. The transceiver integrated circuit of claim 4 characterized in that the LNA includes a plurality of amplifiers.

6. The transceiver integrated circuit of claim 1 characterized in that the transmitter section comprises a power amplifier (PA).

7. The transceiver integrated circuit of claim 6 characterized in that the power amplifier includes a plurality of PAs.

8. The transceiver integrated circuit of claim 1 characterized in that the transmitter section is operably coupled to the local oscillator through a buffer.

9. The transceiver integrated circuit of claim 4 characterized in that the mixer is further coupled to an intermediate frequency amplifier.

10. The transceiver integrated circuit of claim 1 characterized in that the common silicon based integrated circuit is manufactured using a Silicon Germanium Heterojunction Bipolar Transistor (SiGe HBT) integrated circuit technology on a single monolithic silicon substrate.

11. The transceiver integrated circuit of claim 1 characterized in that the common silicon based integrated circuit is manufactured using a Silicon Germanium Bipolar Complementary Metal Oxide Semiconductor (SiGe BiCMOS) integrated circuit technology on a single monolithic silicon substrate.

12. The transceiver integrated circuit of claim 1 characterized in that the transceiver integrated circuit is operable at a supply voltage of 3.3 volts or lower.

13. The transceiver integrated circuit of claim 1 characterized in that the transceiver integrated circuit is operable at a supply voltage of 2.5 volts or lower.

14. The transceiver integrated circuit of claim 1 characterized in that the local oscillator, the receiver section, and the transmitter section are connected to a ground plane, said ground plane comprising:
a. one or more sections of metal each located adjacent to each of the local oscillator, the receiver section, and the transmitter section;
b. air gaps located in between the each section of the metal located adjacent to each of the local oscillator, the receiver section, and the transmitter section; and
c. each section of the metal being connected to the adjacent section of metal of the said ground plane at a location on the edge of the ground plane corresponding to a point equidistant from the two sections of metal.

15. The transceiver integrated circuit of claim 14 characterized in that the point is formed by a portion of the metal that is substantively no smaller than required for a connection point for a power or control signal.

16. The transceiver integrated circuit of claim 1 characterized in that the common silicon-based integrated circuit comprises a plurality of metal layers, each layer corresponding to one of a ground signal, a power signal, or a plurality of bias signals.

17. The transceiver integrated circuit of claim 16 characterized in that the metal layers corresponding to the ground signal are located on alternating metal layers and the remaining layers further alternate between the metal layers corresponding to the power signal and the metal layers corresponding to the plurality of bias signals.

18. The transceiver integrated circuit of claim 1 characterized in that the common silicon-based integrated circuit comprises a plurality of metal layers, each said metal layer consisting of a plurality of square shaped holes located in a grid, wherein two adjacent metal layers are aligned such that the square shaped holes of the relatively higher metal layer are directly above the metal of the relatively lower metal layer.

19. The transceiver integrated circuit of claim 1 characterized in that the common silicon-based integrated circuit further comprises a static frequency divider operable at the same frequency as the RF local oscillation signal.

20. The transceiver integrated circuit of claim 19 characterized in that the receiver section, the transmitter section, and the static frequency divider are each associated with a separate power supply domain.

21. A clock distribution system operable to distribute a clock signal to a plurality of circuit blocks, characterized by:
a. a local oscillator that generates an RF local oscillation signal;
b. a clock driving means operably coupled to the local oscillator;
c. a plurality of further driving means, each said further driving means operably coupled to the clock driving means; and
d. a plurality of circuit blocks, each said circuit block operably connected to one of the driving means;
wherein said RF local oscillation signal is at a frequency ranging from 75 GHz to 110 GHz.

22. The clock distribution system of claim 21 characterized in that the clock driving means is a clock buffer and the plurality of further driving means is a plurality of buffers.

23. The clock distribution system of claim 21 characterized in that the clock driving means is a clock transmission line and the plurality of further driving means is a plurality of transmission lines.

24. A method for radio detection and ranging (RADAR) using a Doppler RADAR transceiver system operable at a transmission frequency ranging from 75 GHz to 110 GHz characterized by:
a. generating an RF local oscillation signal;
b. coupling the RF local oscillation signal to a transmitter, said transmitter operable to transmit the RF local oscillation signal;
c. receiving a reflection of the RF local oscillation signal at a receiver operable to receive an RF signal;
d. multiplying said reflected version of the RF local oscillation signal by the RF local oscillation signal; and
e. establishing a low frequency component of the multiplication.

25. A method for noise isolation among a plurality of circuit blocks connected to a metal plane characterized by:
a. providing air gaps located in between each section of the metal plane located adjacent to each of a plurality of circuit blocks; and
b. connecting each section of the metal plane to an adjacent section of the metal plane at a location on the edge of the metal plane corresponding to a point equidistant from the two sections of the metal plane, wherein the point occupies a portion of the metal no smaller than required for a connection point for a power or control signal.

26. A method for maximizing integrated circuit layout density characterized by providing a plurality of holes oriented in a grid on a metal plane of the integrated circuit, the remaining metal sections of the metal plane operable to enable existing circuit block layouts to be incorporated into the integrated circuit.

27. The method of claim 26 characterized by a plurality of adjacent metal planes on a single integrated circuit die, wherein a plurality of holes is oriented in a grid on each said metal plane, wherein two adjacent metal planes define an upper metal plane and a lower metal plane, such upper metal plane and lower metal plane being aligned such that the holes of the upper metal plane are substantially above the metal of the relatively lower metal layer, and wherein said alignment results in substantially improved noise isolation.

28. The method of claim 26 characterized in that the holes are square shaped and the remaining metal sections are plus shaped, the square shaped holes slightly larger than the centre of the plus shaped metal sections.

29. The method of claim 26, characterized in that the holes and the remaining metal sections are comprised of complementary shapes such that the pattern defined by the holes oriented in a substantially large grid is the same as the pattern defined by the metal sections oriented in a substantially large grid.

30. The method of claim 26, characterized in that the metal planes corresponding to a ground signal are located on alternating metal layers and the remaining layers further alternate between the metal layers corresponding to a power signal and the metal layers corresponding to a plurality of bias signals.

31. The method of claim 30, characterized in that each of the metal layers corresponding to the plurality of bias signals comprises a plurality of isolation structures, each isolation structure placed in between functional blocks of the integrated circuit such that noise transmitted between said functional blocks passes through said isolation structures.

32. The method of claim 31, characterized in that each of the plurality of isolation structures comprises a checker pattern of p-sub regions and n-well regions, each said region connected to one or more of the metal planes corresponding to the ground signal.
